(19) United States
(12) Patent Application Publication
(10) Pub. No.: US 2011/0171445 A1
(43) Pub. Date: Jul. 14, 2011

(54) TRANSPARENT ELECTRODE

(75) Inventors: Hak Gee Jung, Yongin-si (KR); Jeong Han Kim, Seongnam-si (KR); Hyo Jun Park, Yongin-si (KR); Sang Min Song, Yongin-si (KR)

(73) Assignee: KOLON INDUSTRIES, INC., Gwacheon-si, Gyeonggi-do (KR)

(21) Appl. No.: 13/120,033

(22) PCT Filed: Sep. 22, 2009
(86) PCT No.: PCT/KR2009/005374

§ 371 Date: Mar. 21, 2011

(30) Foreign Application Priority Data
Sep. 23, 2008 (KR) 10-2008-0093048

(51) Int. Cl. B32B 7/02; B82Y 99/00

(52) U.S. Cl. 428/216; 977/742

(57) ABSTRACT

Disclosed herein is a transparent electrode, including: a polyimide film having an average linear thermal expansion coefficient of 50.0 ppm/° C. or less, which is measured by thermo-mechanical analysis based on a film thickness of 50˜100 μm at a temperature of 50˜250° C., and a yellowness of 15 or less; and an electrode layer including a conductive material and a polyimide resin having an average linear thermal expansion coefficient of 50.0 ppm/° C. or less, which is measured by thermo-mechanical analysis based on a film thickness of 50˜100 μm at a temperature of 50˜250° C., and a yellowness of 15 or less. The transparent electrode is advantageous in that a problem of a short circuit does not occur even when apparatuses including this transparent electrode are over-heated because it has excellent heat resistance, and in that it is transparent and has high electroconductivity.

### TECHNICAL FIELD

The present invention relates to a transparent electrode, and, more particularly, to a transparent electrode in which an organic electrode layer is formed on a plastic film.

### BACKGROUND ART

As computers, electrical household appliances and communication appliances are digitalized and their performance is rapidly increased, it is keenly required to realize large-size portable displays. Display materials which can be folded and rolled like a newspaper are required in order to realize portable large-area flexible displays.

Therefore, electrode materials for displays not only must be transparent and exhibit low resistance but also must exhibit high strength such that devices can be mechanically stabilized even when they are bent or folded. Further, electrode materials for displays must have a thermal expansion coefficient similar to that of a plastic substrate such that appliances are not short-circuited or their surface resistance is not greatly changed even when they are overheated or their temperature is high.

Since flexible displays enable the manufacture of displays having various shapes, they can be used for the trademarks of clothes, advertising boards, price list panels of goods display stands, large-area illumination apparatuses and the like, whose colors and patterns can be changed, as well as portable displays.

In relation to this, transparent conductive film is widely used in devices requiring both transmissivity and conductivity, such as image sensors, solar cells, various types of displays (PDPs, LCDs, PDPs, etc.) and the like.

Generally, indium tin oxide (ITO), which is used to make a transparent electrode for flexible displays, has been researched actively. However, the indium tin oxide (ITO) is problematic in that high process costs are required because a vacuum process is needed to form an ITO thin film and in that the lifespan of a flexible display becomes short because the ITO thin film easily breaks when the flexible display is bent or folded.

In order to solve the above problems, Korean Unexamined Patent Application Publication No. 10-2005-001589 discloses a method of manufacturing a transparent electrode having a transmissivity of 80% or more and a surface resistance of 100 Ω/sq or less in the visible light range, in which carbon nanotubes are dispersed in or on a coating layer on the nanoscale by chemically bonding carbon nanotubes with polymers and then forming the resulting product into a film or by coating a conductive polymer layer with purified carbon nanotubes or carbon nanotubes chemically bonded with polymers, and then metal nanoparticles, such as gold, silver or the like, are added to the carbon nanotube-dispersed coating layer, thus minimizing the scattering of light in the visible light range and improving conductivity. In this publication, specifically, the transparent electrode is manufactured by reacting a carbon nanotube-dispersed solution with polyethylene terephthalate (PET) to prepare a highly-concentrated carbon nanotube-polymer copolymer solution, applying the copolymer solution onto a polyester film and then drying the copolymer solution.

However, when the transparent electrode manufactured in this way is used at high temperature, polymer modification can occur.

In addition, research into using organic conductive polymers as transparent electrode materials has been made. However, since most of the organic conductive polymers developed to date absorb light in the visible light range, they are not suitable to be used as materials for transparent electrodes.

### DISCLOSURE

### Technical Problem

Accordingly, the present invention has been made keeping in mind the above problems occurring in the prior art, and an object of the present invention is to provide a transparent electrode having excellent transmissivity, in which polymer modification occurs at minimum.

Another object of the present invention is to provide a transparent electrode having high electroconductivity.

### Technical Solution

An aspect of the present invention provides a transparent electrode, including: a polyimide film having an average linear thermal expansion coefficient of 50.0 ppm/° C. or less, which is measured by thermo-mechanical analysis based on a film thickness of 50˜100 μm at a temperature of 50˜250° C., and a yellowness of 15 or less; and an electrode layer including a conductive material and a polyimide resin having an average linear thermal expansion coefficient of 50.0 ppm/° C. or less, which is measured by thermo-mechanical analysis based on a film thickness of 50˜100 μm at a temperature of 50˜250° C., and a yellowness of 15 or less.

In the transparent electrode, the electrode layer may be formed by dispersing the conductive material in the polyimide resin or dispersing the conductive material on a polyimide resin layer.

The polyimide film may have an L value of 90 or more, an a value of 5 or less and a b value of 5 or less when its chromatic coordinates are measured using a UV spectrometer based on a film thickness of 50˜100 μm.

The conductive material may be carbon nanotubes, indium tin oxide (ITO) powder or indium zinc oxide (IZO) powder.

The electrode layer may be composed of varnish including 0.001˜1 parts by weight of carbon nanotubes based on 100 parts by weight of a solid content of the polyimide resin.

Further, the electrode layer is composed of varnish including 2˜100 parts by weight of ITO powder or IZO powder based on 100 parts by weight of the solid content of the polyimide resin.

The ITO powder may include 80˜95 wt % of indium oxide and 5˜20 wt % of tin oxide.

The electrode layer may have a thickness of 10 nm ˜25 um.

The transparent electrode may have a transmissivity of 60% or more at a thickness of 500 nm.

### ADVANTAGEOUS EFFECTS

Since the transparent electrode according to the present invention includes a polyimide film, serving as a substrate, satisfying an average linear thermal expansion coefficient and having a yellowness of 15 or less and an electrode layer formed by dispersing a conductive material in a polyimide resin satisfying an average linear thermal expansion coefficient and having a yellowness of 15 or less, the transparent electrode of the present invention is advantageous in that a problem of a short circuit does not occur even when apparatuses including this transparent electrode are over-heated because it has excellent heat resistance, and in that it is transparent and has high electroconductivity.

### BEST MODE

Hereinafter, preferred embodiments of the present invention will be described in detail.

A transparent electrode according to an embodiment of the present invention includes a polyimide film, serving as a substrate, having an average linear thermal expansion coefficient of 50.0 ppm/° C. or less, which is measured by thermo-mechanical analysis based on a film thickness of 50˜100 μm at a temperature of 50˜250° C., and a yellowness of 15 or less. When the average linear thermal expansion coefficient of the polyimide film is more than 50.0 ppm/° C., the difference in thermal expansion coefficient between the polyimide film and a plastic substrate is increased, so that there is a problem in that a short circuit occurs when apparatuses provided with the transparent electrode are over-heated or when their temperature is high. Further, when the yellowness of the polyimide film is more than 15, the transparency of the transparent electrode decreases, so that it is not preferable that the polyimide film be used to manufacture the transparent electrode. In this case, the average linear thermal expansion coefficient of the polyimide film is obtained by measuring the change in length of the polyimide film depending on the increase of temperature at a predetermined temperature range, and may be measured using a thermo-mechanical analyzer. It is preferred that the average linear thermal expansion coefficient of the polyimide film be 35.0 ppm/° C. or less.

Further, in terms of transmissivity, it is preferred that a colorless transparent plastic film, specifically, a polyimide film having a yellowness of 15 or less based on a film thickness of 50˜100 μm be used. Moreover, a polyimide film having an average transparency of 85% or more at a wavelength of 380˜780 nm, when measured using a UV spectrometer based on film thickness of 50˜100 μm, may be used as the plastic film. When the polyimide film satisfies the above transparency conditions, it can be used as a plastic substrate for transmissive electronic paper, liquid crystal displays (LCDs) and organic light-emitting diodes (OLEDs). Furthermore, a polyimide film having an average transparency of 88% or more at a wavelength of 550 nm or an average transparency of 70% or more at a wavelength of 420 nm, when measured using a UV spectrometer based on a film thickness of 50˜100 μm, may be used as the plastic film.

Further, in terms of increasing transmissivity by improving transparency, a polyimide film having a L value of 90 or more, an a value of 5 or less and a b value of 5 or less, when its chromatic coordinates are measured using a UV spectrometer based on a film thickness of 50˜100 μm, may be used.

The polyimide film can be formed by polymerizing aromatic dianhydride with aromatic diamine to prepare polyamic acid and then imidizing the polyamic acid. Examples of the aromatic dianhydride may include, but are not limited to, one or more selected from among 2,2-bis(3,4-dicarboxyphenyl)hexafluoropropane dianhydride (6-FDA), 4-(2,5-dioxoterahydrofuran-3-yl)-1,2,3,4-tetrahydronaphthalene-1,2-dicarboxylic anhydride (TDA), 4,4′-(4,4′-isopropylidenediphenoxy)bis(phthalicanhydride) (HBDA), pyromellitic dianhydride (PMDA), biphenyltetracarboxylic dianhydride (BPDA), and oxydiphthalic dianhydride (ODPA).

Examples of the aromatic diamine may include, but are not limited to, one or more selected from among 2,2-bis[4-(4-aminophenoxy)-phenyl]propane (6HMDA), 2,2′-bis(trifluoromethyl)-4,4′-diaminobiphenyl (2,2′-TFDB), 3,3′-bis(trifluoromethyl)-4,4′-diaminobiphenyl (3,3′-TFDB), 4,4′-bis(3-aminophenoxy)diphenylsulfone (DBSDA), bis(3-aminophenyl)sulfone (3DDS), bis(4-aminophenyl)sulfone (ODDS), 1,3-bis(3-aminophenoxy)benzene (APB-133), 1,4-bis(4-aminophenoxy)benzene (APB-134), 2,2′-bis[3(3-aminophenoxy)phenyl]hexafluoropropane (3-BDAF), 2,2′-bis[4(4-aminophenoxy)phenyl]hexafluoropropane (4-BDAF), 2,2′-bis(3-aminophenyl)hexafluoropropane (3,3′-6F), 2,2′-bis(4-aminophenyl)hexafluoropropane (4,4′-6F), and oxydianiline (ODA).

Methods of preparing a polyimide film using monomers are not particularly limited. For example, the polyimide film can be prepared by polymerizing aromatic diamine with aromatic dianhydride in a first solvent to form a polyamic acid solution, imidizing the polyamic acid solution, mixing the imidized polyamic acid solution with a second solvent to form a mixed solution and then filtering and drying the mixed solution to obtain a solid polyimide resin, and then dissolving the solid polyimide resin in the first solvent to form a polyimide solution and then forming the polyimide solution into a film through a film forming process. In this case, the second solvent may have lower polarity than the first solvent. Specifically, the first solvent may be one or more selected from among m-cresol, N-methyl-2-pyrrolidone (NMP), dimethylformamide (DMF), dimethylacetamide (DMAc), dimethylsulfoxide (DMSO), acetone and diethyl acetate, and the second solvent may be one or more selected from among water, alcohols, ethers and ketones.

Meanwhile, when a metal film is formed on a plastic film, in order to form a metal film having uniform thickness, the plastic film may have a surface flatness of 2 μm or less, preferably, 0.001˜0.04 μm.

An electrode layer is formed on this polyimide film substrate. The electrode layer may be a resin layer in which a conductive material is dispersed in a polyimide resin satisfying the characteristics of the above-mentioned polyimide film. Here, it means that the conductive material may be dispersed in the polyimide resin or on a polyimide resin layer.

A resin layer in which carbon nanotubes, indium tin oxide (ITO) powder or indium zinc oxide (IZO) powder are dispersed, or a resin film on which carbon nanotubes, indium tin oxide (ITO) powder or indium zinc oxide (IZO) powder are dispersed can be used as the electrode layer. The resin layer in which carbon nanotubes, indium tin oxide (ITO) powder or indium zinc oxide (IZO) powder are dispersed may obtained by applying a transparent polyimide varnish containing carbon nanotubes, ITO powder or IZO powder or may be formed by dispersing carbon nanotubes, ITO powder or IZO powder in a transparent polyimide varnish and then applying the dispersed transparent polyimide varnish.

In this case, in terms of the surface resistance and light transmittance of an electrode film for display, the polyimide varnish may include 0.001˜1 part by weight of carbon nanotubes based on 100 parts by weight of a solid resin therein.

Meanwhile, the kinds of carbon nanotubes may include, but are not limited to, single-wall carbon nanotubes (SWCNTs), double-wall carbon nanotubes (DWCNTs), multi-wall carbon nanotubes (MWCNTs), reformed carbon nanotubes obtained by reforming carbon nanotubes through chemical or physical treatment, and the like.

Further, methods of dispersing carbon nanotubes in a varnish are not particularly limited. For example, carbon nanotubes may be dispersed in a varnish by chemical-bonding the carbon nanotubes with monomers in the varnish through physical treatment, such as ultrasonic dispersion, three roll dispersion, homogenization, kneading, mill-blending, ball-milling or the like, and chemical treatment. In this case, the introduction of carbon nanotubes (CNTs) may be performed through an in-situ method during varnish polymerization or a blending method after the varnish polymerization. Further, in order to appropriately disperse CNTs, an additive, such as a dispersant, an emulsifier or the like, may be used.

A carbon nanotube-dispersed resin layer may be formed using a casting method, such as a spin coating method, a doctor blade method or the like, but the present invention is not limited thereto.

In particular, it is preferred that a carbon nanotube-dispersed polyimide resin layer be used as an electrode layer because its conductivity can be improved due to the peculiar structure of carbon nanotubes without causing its transparency to be deteriorated.

Further, in the formation of the carbon nanotube-dispersed resin layer, a process of aligning carbon nanotubes using electrical or mechanical friction may be performed after the dispersion of carbon nanotubes in a resin layer or after the formation of an electrode layer including carbon nanotubes. Owing to the process of aligning carbon nanotubes, the electroconductivity of carbon nanotubes is improved. Also, owing to using a transparent resin layer including carbon nanotubes as an optical waveguide, optical movability and spreadability are increased, thus increasing the functionality as a source for light emissions.

When ITO powder or IZO powder is used together with or instead of carbon nanotubes, the amount thereof may be 2˜100 parts by weight based on 100 parts by weight of a solid resin in a varnish.

The electrical characteristics of the electrode layer when ITO powder is added can be adjusted depending on the amount of an indium-tin oxide (ITO) mixture or the mixing ratio of indium oxide to tin oxide in the mixture. The indium-tin oxide mixture may include 80˜95 wt % of indium oxide (In₂O₃) and 5˜20 wt % of tin oxide (SnO₂). The indium-tin oxide mixture may be powdered, and may have an average minimum diameter of 30˜70 nm and an average maximum diameter of 60˜120 nm although its size depends on the kinds of materials in use and reaction conditions.

Methods of preparing a varnish including the indium-tin oxide mixture are not particularly limited. For example, the varnish including the indium-tin oxide mixture may be prepared by dispersing the mixture in a polyamic acid solution. It is advantageous in terms of realizing conductivity or maintaining softness that the amount of the indium-tin oxide mixture be 2˜100 parts by weight based on 100 parts by weight of solid polyamic acid.

Methods of introducing the indium-tin oxide mixture into the polyamic acid solution are not particularly limited. Examples of these methods may include a method of adding the indium-tin oxide mixture to the polyamic acid solution before or during polymerization, a method of kneading the indium-tin oxide mixture after the polymerization of the polyamic acid, a method of preparing a dispersion liquid including the indium-tin oxide mixture and then mixing the dispersion liquid with the polyamic acid solution, and the like. In this case, the dispersibility of the indium-tin oxide mixture is influenced by the acidity-basicity and viscosity of the dispersion liquid, and the uniform conductivity and visible-light transmissivity of the electrode layer is influenced by the dispersibility of the indium-tin oxide mixture, so that a process of dispersing the indium-tin oxide mixture must be sufficiently performed. The process of dispersing the indium-tin oxide mixture may be performed using a three-roll disperser, an ultrasonic disperser, a homogenizer, a ball mill or the like.

In the formation of a resin layer in which CNTs, ITO powder or IZO powder are dispersed, it is advantageous in that the deterioration of optical properties, such as transmissivity and the like, of displays can be prevented when the resin layer has a thickness of 10 nm ˜25 um.

The transparent electrode film obtained in this way can realize a bright image because its electroconductivity is improved without decreasing the transmissivity of incident light, particularly, because it exhibits high light transmissivity compared to an electrode film composed of only carbon nanotubes.

The transparent electrode film according to an embodiment of the present invention may have a surface resistance of 400 Ω/sq or less and a light transmittance of 60% or more at a wavelength of 500 nm.

### MODE FOR INVENTION

Hereinafter, the present invention will be described in more detail with reference to the following Examples. However, the scope of the present invention is not limited thereto.

### Preparation of Polyimide Film

### Preparation Example 1

A polyimide precursor solution (solid content: 20%) was prepared by polycondensing 2,2′-bis(trifluoromethyl)-4,4′-diaminobiphenyl (2,2′-TFDB) and biphenyltetracarboxylic dianhydride (BPDA) with 2,2-bis(3,4-dicarboxyphenyl)hexafluoropropane dianhydride (6-FDA) in dimethylacetamide using a commonly-used method. This reaction procedure is represented by Reaction Formula 1 below.

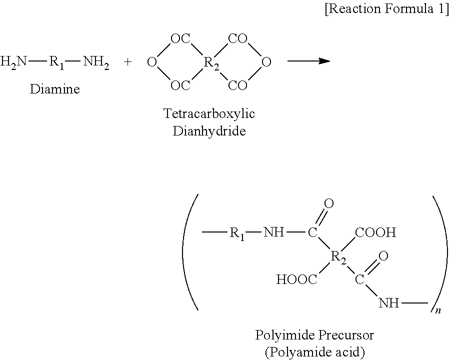

Subsequently, 2˜4 equivalents of acetic anhydride (Samjeon Chemical Co., Ltd.) and pyridine (Samjeon Chemical Co., Ltd.), serving as curing agents, were respectively added to 300 g of the polyimide precursor solution to form a polyamic acid solution. Then, the polyamic acid solution was heated at a heating rate of 1˜10° C./min for 2˜10 hours to a temperature of 20˜180° C. to partially imidize (partially cure) the polyamic acid solution, thereby preparing a solution containing a partially-imidized (partially-cured) intermediate.

The following Reaction Formula 2 represents a reaction procedure used to obtain a polyimide film by heating the polyimide precursor. In the present invention, the polyimide precursor was not completely imidized into polyimide, but was partially imidized into polyimide at a predetermined ratio.

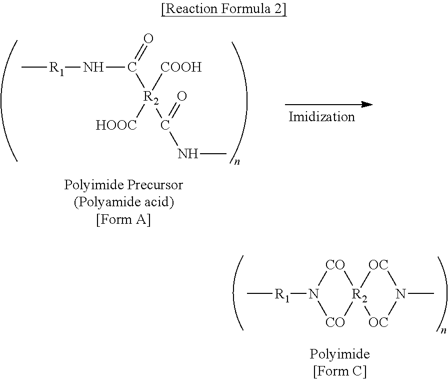

Specifically, when the polyimide precursor solution was heated and stirred under predetermined conditions, dehydration and ring-closing reactions occurred between a hydrogen atom of an amide group and a carboxylic group in the polyimide precursor through the reaction represented by Reaction Formula 2 to form a form B (intermediate) and a form C (imide) as represented by Chemical Formula 1 below. In addition, a form A (polyimide precursor), which was not completely dehydrated, exists in a molecular chain.

That is, as represented by Chemical Formula 1, a form A (polyimide precursor), a form B (intermediate) and a form C (imide) mixedly exist in the molecular chain in which the polyimide precursor is partially imidized.

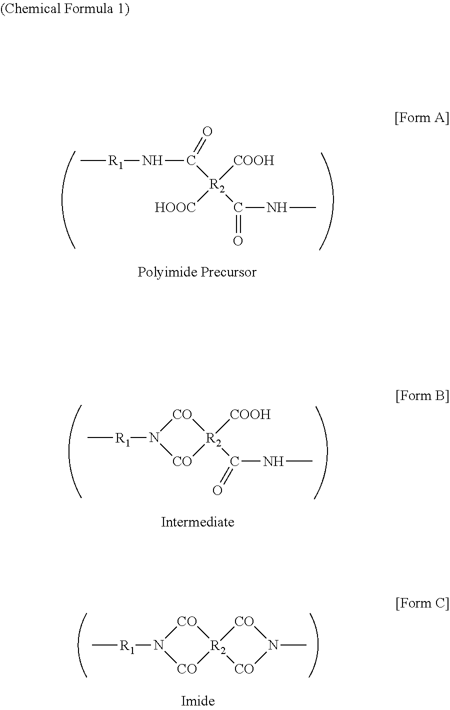

Therefore, 30 g of the imidized solution including the form A, form B and form C was dissolved in 300 g of water to precipitate solid matter, and then the precipitated solid matter was finely powdered through filtering and pulverizing processes and then dried in a vacuum oven at a temperature of 80˜100° C. for 2˜6 hours to obtain about 8 g of solid resin powder. Through the above processes, the form A (polyimide precursor) was converted into the form B or the form C. This solid resin powder was dissolved in 32 g of DMAc or DMF, which is a solvent for polymerization, to obtain 20 wt % of a polyimide solution. The obtained polyimide solution was heated at a heating rate of 1˜10° C./min for 2˜8 hours to a temperature of 40˜400° C. to obtain a polyimide film having a thickness of 50 μm and 100 μm.

The state in which this polyimide precursor was partially imidized is represented by Reaction Formula 3 below.

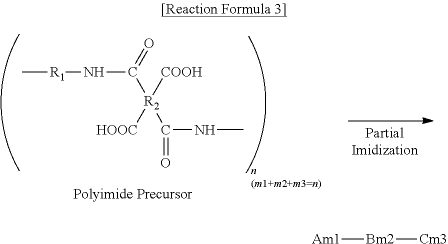

For example, under the above-mentioned conditions, about 45˜50% of the polyimide precursor was imidized and thus cured. The imidization ratio of the polyimide precursor, which is partially imidized, can be controlled by changing heating temperature or time, and, preferably, is about 30˜90%.

Further, in the process of partially imidizing the polyimide precursor, when the polyimide precursor is imidized through dehydration and ring-closing reactions, water is produced, and this water causes the hydrolysis of the amide of the polyimide precursor or the disconnection of a molecular chain, thus deteriorating stability. Therefore, the water is removed by additionally performing an azeotropic reaction using toluene or xylene at the time of heating the polyimide precursor solution or by volitilizing the above-mentioned dehydrating agent.

Subsequently, a coating solution was prepared by mixing the partially-cured intermediate with the solvent used to prepare the polyimide precursor such that the amount of the polyimide precursor is 20˜30 parts by weight based on 100 parts by weight of the coating solution.

Subsequently, the resin solution was applied on a substrate for film formation using spin coating or a doctor blade, and was then formed into a film having a thickness of 50 μm through the above-mentioned high-temperature drying process. In this case, the film formed in this way has the same refractive index over the entire surface thereof because only one side of the film, taken along a vertical or horizontal axis, underwent a stretching process.

### Preparation Example 2

34.1904 g of N,N-dimethylacetamide (DMAc) was charged in a 100 mL 3-neck round-bottom flask, as a reactor, provided with a stirrer, a nitrogen injector, a dropping funnel, a temperature controller and a cooler while passing nitrogen through the flask, and then the reactor is cooled to 0° C., and then 4.1051 g (0.01 mol) of 6-HMDA was dissolved in the N,N-dimethylacetamide (DMAc) to form a first solution, and then the first solution was maintained at 0° C. Subsequently, 4.4425 g (0.01 mol) of 6-FDA was added to the first solution to form a second solution, and then the second solution was stirred for 1 hour to completely dissolve 6-FDA in the second solution. In this case, the concentration of solid matter in the second solution was 20 wt %. Thereafter, this second solution was stirred for 8 hours at room temperature to obtain a polyamic acid solution having a viscosity of 2400 cps at 23° C.

After the reaction was completed, the obtained polyamic acid solution was applied on a glass substrate to a thickness of 500˜1000 μm using a doctor blade, and then dried in a vacuum oven at 40° C. for 1 hour and at 60° C. for 2 hours to obtain a self standing film. Subsequently, the obtained self standing film was heated at a heating rate of 5° C./min in a high-temperature furnace at 80° C. for 3 hours, at 100° C. for 1 hour, at 200° C. for 1 hour and at 300° C. for 30 minutes to prepare a polyimide film having a thickness of 50 μm.

### Preparation Example 3

Similar to in Preparation Example 2, 2.87357 g (0.007 mol) of 6-HMDA was dissolved in 32.2438 g of N,N-dimethylacetamide (DMAc) to form a first solution, and then 0.7449 g (0.003 mol) of 4-DDS was added to the first solution and then completely dissolved therein to form a second solution. Subsequently, 4.4425 g (0.01 mol) of 6-FDA was added to the second solution to form a third solution, and then the third solution was stirred for 1 hour to completely dissolve 6-FDA in the third solution. In this case, the concentration of solid matter in the third solution was 20 wt %. Thereafter, this third solution was stirred for 8 hours at room temperature to obtain a polyamic acid solution having a viscosity of 2300 cps at 23° C.

Thereafter, a polyimide film was prepared using the same method as in Preparation Example 2.

### Preparation Example 4

Similar to in Preparation Example 2, 4.1051 g (0.01 mol) of 6-HMDA was dissolved in 32.4623 g of N,N-dimethylacetamide (DMAc) to form a first solution, and then 3.1097 g (0.007 mol) of 6-FDA was added to the first solution to form a second solution. Subsequently, 0.90078 g (0.003 mol) of TDA was added to the second solution to form a third solution, and then the third solution was stirred for 1 hour to completely dissolve 6-FDA and TDA in the third solution. In this case, the concentration of solid matter in the third solution was 20 wt %. Thereafter, this third solution was stirred for 8 hours at room temperature to obtain a polyamic acid solution having a viscosity of 2200 cps at 23° C.

Thereafter, a polyimide film was prepared using the same method as in Preparation Example 2.

### Preparation Example 5

Similar to in Preparation Example 2, 2.9233 g (0.01 mol) of APB-133 was dissolved in 29.4632 g of N,N-dimethylacetamide (DMAc) to form a first solution, and then 4.4425 g (0.01 mol) of 6-FDA was added to the first solution to form a second solution, and then the second solution was stirred for 1 hour to completely dissolve 6-FDA in the second solution. In this case, the concentration of solid matter in the second solution was 20 wt %. Thereafter, this second solution was stirred for 8 hours at room temperature to obtain a polyamic acid solution having a viscosity of 1200 cps at 23° C.

Thereafter, a polyimide film was prepared using the same method as in Preparation Example 2.

The physical properties of the polyimide films obtained from Preparation Examples 1 to 5 were measured as follows, and the results thereof are given in Table 1 below.

(1) Transmissivity and Chromatic Coordinate

The visible light transmission of each of the prepared polyimide films was measured using a UV spectrometer (Cary100, manufactured by Varian Co., Ltd.).

Further, the chromatic coordinates thereof was measured according to ASTM E 1347-06 standards using a UV spectrometer (Cary100, manufactured by Varian Co., Ltd.), and the values measured at CIE D65 as an illuminant were used.

(2) Yellowness

The yellowness thereof was measured according to ASTM E313 standards.

(3) Linear Thermal Expansion Coefficient

The average linear thermal expansion coefficient thereof at a temperature of 50˜250° C. was measured using a thermo-mechanical analyzer (TMA) (Q400, manufactured by TA Instrument Co., Ltd.) through a thermo-mechanical analysis (TMA) method.

TABLE 1

| | | | linear | | | | | | | | | |
|---|---|---|---|---|---|---|---|---|---|---|---|---|
| | | | expansion | | transmissivity | | | | | | | |
| | | thickness | coefficient | yellow- | 380~780 | 551~780 | 550 | 500 | 420 | chromatic coordinate | | |
| Class. | | (μm) | (ppm/° C.) | ness | nm | nm | nm | nm | nm | L | a | b |
| Prep. | 1 | 50 | 21.6 | 2.46 | 86.9 | 90.5 | 89.8 | 89.3 | 84.6 | 96.22 | −0.27 | 1.03 |
| Exp. | 2 | 50 | 46 | 1.59 | 87.6 | 90.0 | 89.7 | 89.2 | 85.4 | 95.85 | −0.12 | 0.99 |
| | 3 | 50 | 35 | 2.76 | 87.9 | 89.6 | 89.5 | 89.0 | 58.6 | 95.61 | −0.42 | 1.91 |
| | 4 | 50 | 40 | 3.45 | 88.2 | 90.0 | 89.8 | 89.3 | 60.1 | 95.56 | −0.49 | 2.05 |
| | 5 | 50 | 46.0 | 6.46 | 83.8 | 88.8 | 87.2 | 84.8 | 73.2 | 94.6 | 0.59 | 5.09 |

### Examples 1 to 11 and Comparative Examples 1 to 4

Polyimide varnish (in this case, each of the polyamic acid compositions obtained from the Preparation Examples 1 to is used as a polyimide composition), in which carbon nanotubes (SWNT, manufactured by CNI Co., Ltd.) are dispersed such that the mixing ratio of carbon nanotubes to solid content of a transparent polyimide resin is 0.001˜1 wt %, was applied on each of the polyimide films obtained from the Preparation Examples 1 to 5 through casting or spraying to form a carbon nanotube-dispersed resin layer. In addition to this, in the formation of the carbon nanotube-dispersed resin layer, 2˜100 parts by weight of ITO powder based on 100 parts by weight of the solid content of a polyimide resin was additionally mixed and dispersed therein (Examples 10 to 11).

The carbon nanotube content, ITO powder content and thickness of the carbon nanotube-dispersed resin layer are given in Table 2 below.

TABLE 2

| | | Electrode layer | | |
|---|---|---|---|---|
| | Polyimide | thickness | | ITO powder |
| | film | (um) | CNT content* | content* |
| Exp. 1 | Prep. Exp. 1 | 0.4 | 0.01 | — |
| Exp. 2 | Prep. Exp. 2 | 1.2 | 0.01 | — |
| Exp. 3 | Prep. Exp. 1 | 2.5 | 0.01 | — |
| Exp. 4 | Prep. Exp. 5 | 0.4 | 0.02 | — |
| Exp. 5 | Prep. Exp. 1 | 1.2 | 0.02 | — |
| Exp. 6 | Prep. Exp. 2 | 2.5 | 0.02 | — |
| Exp. 7 | Prep. Exp. 1 | 0.4 | 0.05 | — |
| Exp. 8 | Prep. Exp. 5 | 1.2 | 0.05 | — |
| Exp. 9 | Prep. Exp. 1 | 2.5 | 0.05 | — |
| Exp. 10 | Prep. Exp. 1 | 2.5 | 0.01 | 5 |
| Exp. 11 | Prep. Exp. 1 | 2.5 | 0.01 | 25 |
| Comp. Exp. 1 | Prep. Exp. 2 | ITO-deposited layer having a thickness of | | |
| Comp. Exp. 2 | Prep. Exp. 3 | 50~150 nm | | |
| Comp. Exp. 3 | Prep. Exp. 1 | | | |
| Comp. Exp. 4 | Prep. Exp. 1 | — | — | 25 |

(note)
*are indicate by parts by weight based on 100 parts by weight of solid content of polyamic acid included in varnish

### Experimental Example 1

The characteristics of the transparent electrode films obtained from the Examples 1 to 13 and Comparative Examples 1 to 4 were evaluated as follow, and the results thereof are given in Table 3 below.

(1) Optical Properties

The visible light transmission of each of the prepared transparent electrode films was measured using a UV spectrometer (Cary100, manufactured by Varian Co., Ltd.).

(2) Surface Resistance

The surface resistance values thereof were measured ten times using a high resistance meter (Hiresta-UP MCT-HT450, manufactured by Mitsubishi Chemical Corp.) having a measuring range of 10×10⁵˜10×10¹⁵ and a low resistance meter (CMT-SR 2000N, manufactured by Advanced Instrument Technology (AIT) Corp., 4-Point Probe System) having a measuring range of 10×10⁻³˜10×10⁵, and then the average value of the measured resistance values was calculated.

TABLE 3

| | Surface resistance | Transmissivity |
|---|---|---|
| | (Ω/Sq) | (500 nm, %) |
| Exp. 1 | 7.0 × 10⁶ | 88.5 |
| Exp. 2 | 4.7 × 10⁶ | 88.2 |
| Exp. 3 | 2.8 × 10⁶ | 88.1 |
| Exp. 4 | 5.0 × 10⁵ | 88.1 |
| Exp. 5 | 2.0 × 10⁵ | 87.8 |
| Exp. 6 | 6.0 × 10⁵ | 87.4 |
| Exp. 7 | 5.0 × 10³ | 87.7 |
| Exp. 8 | 3.0 × 10³ | 87.0 |
| Exp. 9 | 2.3 × 10³ | 86.5 |
| Exp. 10 | 4.5 × 10³ | 87.2 |
| Exp. 11 | 2.2 × 10³ | 87.5 |
| Comp. Exp. 1 | 2.0 × 10³ | 87.2 |
| Comp. Exp. 2 | 7.0 × 10² | 86.9 |
| Comp. Exp. 3 | 5.0 × 10² | 87.8 |
| Comp. Exp. 4 | 4.0 × 10² | 87.1 |

From the results of Table 3, it can be seen that it is possible to manufacture a transparent electrode having low resistance with the increase in amount of carbon nanotubes.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A transparent electrode, comprising:
a polyimide film having an average linear thermal expansion coefficient of 50.0 ppm/° C. or less, which is measured by thermo-mechanical analysis based on a film thickness of 50˜100 μm at a temperature of 50˜250° C., and a yellow index of 15 or less; and
an electrode layer including a conductive material and a polyimide resin having an average linear thermal expansion coefficient of 50.0 ppm/° C. or less, which is measured by thermo-mechanical analysis based on a film thickness of 50-100 μm at a temperature of 50-250° C., and a yellow index of 15 or less.

2. The transparent electrode according to claim 1, wherein the electrode layer is formed by dispersing the conductive material in the polyimide resin or dispersing the conductive material on a polyimide resin layer.

3. The transparent electrode according to claim 1, wherein the polyimide film has an L value of 90 or more, a value of 5 or less and a b value of 5 or less when its chromatic coordinates are measured using a UV spectrometer based on a film thickness of 50-100 μm.

4. The transparent electrode according to claim 1, wherein the conductive material includes carbon nanotubes, indium tin oxide (ITO) powder or indium zinc oxide (IZO) powder.

5. The transparent electrode according to claim 1, wherein the electrode layer is composed of varnish including 0.001-1 parts by weight of carbon nanotubes based on 100 parts by weight of a solid content of the polyimide resin.

6. The transparent electrode according to claim 1, wherein the electrode layer is composed of varnish including 2-100 parts by weight of ITO powder or IZO powder based on 100 parts by weight of a solid content of the polyimide resin.

7. The transparent electrode according to claim 6, wherein the ITO powder includes 80-95 wt % of indium oxide and 5-20 wt % of tin oxide.

8. The transparent electrode according to claim 1, wherein the electrode layer has a thickness of 10 nm-25 μm.

9. The transparent electrode according to claim 1, wherein the transparent electrode has a transmissivity of 60% or more at 500 nm.

10. The transparent electrode according to claim 4, wherein the electrode layer is composed of varnish including 0.001-1 parts by weight of carbon nanotubes based on 100 parts by weight of a solid content of the polyimide resin.

11. The transparent electrode according to claim 4, wherein the electrode layer is composed of varnish including 2-100 parts by weight of ITO powder or IZO powder based on 100 parts by weight of a solid content of the polyimide resin.

12. The transparent electrode according to claim 11, wherein the ITO powder includes 80-95 wt % of indium oxide and 5-20 wt % of tin oxide.

13. The transparent electrode according to claim 4, wherein the electrode layer has a thickness of 10 nm-25 μm.

14. The transparent electrode according to claim 4, wherein the transparent electrode has a transmissivity of 60% or more at 500 nm.
